(19) United States
(12) Patent Application Publication
(10) Pub. No.: US 2024/0368009 A1
(43) Pub. Date: Nov. 7, 2024

(54) FUNCTIONALIZED POLYMERS FOR THE REMOVAL OF SOLUBLE AND INSOLUBLE TRANSITION METALS FROM WATER

(71) Applicant: BL Technologies, Inc., Minnetonka, MN (US)

(72) Inventors: Edward Urankar, Minnetonka, MN (US); Lisa Spagnola, Minnetonka, MN (US); Gregory Kaplan, Minnetonka, MN (US)

(21) Appl. No.: 18/553,824

(22) PCT Filed: Mar. 29, 2022
(86) PCT No.: PCT/US2022/022333

§ 371 Date: Oct. 3, 2023

Related U.S. Application Data
(60) Provisional application No. 63/170,074, filed on Apr. 2, 2021.

(51) Int. Cl. C02F 1/56; C02F 101/20; C08H 7/00

(52) U.S. Cl. CPC C02F 1/56; C08H 6/00; C02F 2101/20

(57) ABSTRACT

A functionalized polymeric composition having a backbone, and at least one compound having at least one thiol-functional group or at least one amino-functional group. A method of preparing a functionalized polymeric composition, the method (i) providing a backbone; and (ii) reacting the backbone with an amino-thiol compound to obtain a functionalized polymeric composition. A method for removing metals from an aqueous stream, the method (i) providing a functionalized polymeric composition; (ii) adding the functionalized polymeric composition to an aqueous stream comprising a plurality of metal contaminants; (iii) allowing the polymeric composition to react with the metal contaminants to form an insoluble complex; and (iv) allowing the insoluble complex to settle out of solution or remove the insoluble complex through filtration.

### CROSS REFERENCE TO RELATED APPLICATION

This is a U.S. National Stage Entry of International Application No. PCT/US2022/022333, filed Mar. 29, 2022 which claims the benefit of priority to U.S. Provisional Patent Application Ser. No. 63/170,074 filed Apr. 2, 2021, which are incorporated by reference herein in their entirety.

### FIELD OF THE DISCLOSURE

The disclosed technology generally provides for a water-soluble functionalized polymeric composition and method for removing both soluble and insoluble metal ions in water, and more specifically, a water-soluble functionalized polymeric composition that reacts with soluble and insoluble metal ions in water to precipitate out of solution and settle by gravity, thus removing the total metal concentration in the supernatant.

### BACKGROUND

Polymeric dithiocarbamates are well known in the industry to removal heavy metals from contaminate waters. The polymeric structure of polymeric dithiocarbamates have benefits in both their aquatic toxicity profile and ability to precipitate over smaller organo-sulfide compounds. However, the raw materials have handling dangers. In addition, while excellent for some transition metals, polymeric dithiocarbamates lack in their affinity to others.

Thus, what is needed in the art is a non-dithiocarbamate polymer that is easily manufactured and contains raw materials that are easily handled and provides affinity to transition metals.

### SUMMARY

The disclosed technology generally provides for a water-soluble functionalized polymeric composition and method for removing both soluble and insoluble metal ions in water. More specifically, the disclosed technology provides for a water-soluble functionalized polymeric composition that reacts with soluble and insoluble metal ions in water to precipitate out of solution and settle by gravity, thus removing the total metal concentration in the supernatant.

In one aspect of the disclosed technology, a functionalized polymeric composition is provided. The composition comprising: a backbone; and at least one compound having at least one thiol-functional group or at least one amino-functional group.

In some embodiments, the backbone comprises a nitrogen-containing polymer, a maleic anhydride copolymer, a tannin, or polymeric scaffold. In some embodiments, the nitrogen-containing polymer is a polyamine having a Mw of at least 2,000 and wherein the polymer comprises at least one primary or secondary amine capable of functionalization.

In some embodiments, the nitrogen containing polymer is polyethylenimine (PEI). In some embodiments, the compound is cysteamine, a thiolactone, or derivative thereof.

In yet another aspect of the disclosed technology, a method of preparing a functionalized polymeric composition is provided. The method comprising: (i) providing a backbone; (ii) reacting said backbone with an amino-thiol compound to obtain a functionalized polymeric composition.

In some embodiments, the backbone comprises a nitrogen-containing polymer, a maleic anhydride copolymer, a tannin, or polymeric scaffold. In some embodiments, the amino-thiol compound is cysteamine, thiolactone, or derivative thereof. In some embodiments, the functionalized polymeric composition is water soluble.

In yet another aspect of the present technology, a method for removing metals from an aqueous stream is provided. The method comprising: (i) providing a functionalized polymeric composition; (ii) adding the functionalized polymeric composition to an aqueous stream comprising a plurality of metal contaminants; (iii) allowing the polymeric composition to react with the metal contaminants to form an insoluble complex; and (iv) allowing said insoluble complex to settle out of solution or remove the insoluble complex through filtration.

In some embodiments, the functionalized polymeric composition comprises a backbone, and at least one compound having at least one thiol-functional group or at least one amino-functional group.

In some embodiments, the aqueous stream is provided by cooling tower blowdown, incinerator scrubbers, municipal water streams, mining operations, metal finishing operations, or oil refinery operations.

In some embodiments, the functionalized polymeric composition complexes with the metal contaminants. In some embodiments, the metal contaminants comprise at least one transition metal, post-transition metal, lanthanide, actinide, arsenic, selenium, and/or tellurium.

In some embodiments, the transition metal is a cationic transition metal. In some embodiments, the cationic transition metal comprises Ag, Cu, Cd, Co, Hg, Ni, Pb, Pd, Pt, Tl, and/or Zn. In some embodiments, the cationic transition metal is divalent or monovalent.

### DETAILED DESCRIPTION OF EXEMPLARY EMBODIMENTS

The disclosed technology generally provides for a water-soluble functionalized polymeric composition and method for removing both soluble and insoluble metal ions in water. The disclosed functionalized polymeric composition reacts with soluble and insoluble metal ions in water, where the reacted polymer can precipitate out of solution and settle by gravity, thus removing the total metal concentration in the supernatant.

In one aspect of the disclosed technology, a functionalized polymeric composition is provided. The functionalized polymeric composition comprises a backbone; and at least one compound having at least one thiol-functional group and/or at least one amino-functional group.

The functionalized polymeric composition as disclosed herein is a non-dithiocarbamate polymer that is easily manufactured and contains raw materials that are easily handled. Additionally, the present technology provides much safer raw materials than carbon disulfide and uses much less expensive backbones than conventionally used.

The disclosed functionalized polymeric composition and method allows for removal of many transition metals, such as, but not limited to, Cu, Cd, Co, Hg, Pb, and Zn, where the removal of zinc is improved over polymeric dithiocarbamates. Also, the disclosed functionalized polymeric composition and method provides the same or similar removal of soluble Cd, Cu, Ni, Pb, Zn, and Hg on an actives base as dithiocarbamate functionalized polymers in synthetic water after filtration.

The disclosed functionalized polymeric composition comprises a backbone. It should be understood that the backbone as described herein can be preexisting or can be functionalized during the creation/building of the backbone itself. In some embodiments, the backbone comprises a nitrogen-containing polymer, a maleic anhydride copolymer, a tannin, or polymeric scaffold.

In some embodiments, the nitrogen-containing polymer is a polyamine having a Mw of at least 2,000, and wherein the polymer comprises at least one primary or secondary amine capable of functionalization. In some embodiments, the nitrogen containing polymer is polyethylenimine (PEI). In some embodiments, additional nitrogen containing polymers may include, but are not limited to, polyvinylamine, polyallyamine, poly(diallyl)amine, and epichlorohydrin based polyamine polymers, such as those disclosed in U.S. Pat. Nos. 4,670,160 and 4,670,180.

In some embodiments, the backbone comprises a maleic anhydride copolymer. For example, by using a maleic anhydride copolymer backbone with cysteamine, the precipitation can be controlled by the presence of hardness in the water/aqueous stream. An added advantage to maleic anhydride cysteamine products is the ease of manufacturing over polymeric dithiocarbamates, which require more specialized reactors.

In some embodiments, the backbone comprises a tannin. In some embodiments, the tannin can be obtained from a Mannich reaction. In some embodiments, the tannin can be obtained from a Mannich reaction of the tannin with thiol-amine compound with or without additional amino compounds.

In some embodiments, the compound having at least one thiol-functional group and/or at one least one amino-functional group is cysteamine, a thiolactone, or derivative thereof. In some embodiments, for example, the combination of cysteamine with tannin backbone provides a wider range and improved removal of metals over traditional tannin polymer chemistry. In some embodiments, for example, thiolactone chemistry provides far less difficulty when handling or safety concerns than carbon disulfide, and therefore, the manufacturing process for a thiol can be done with standard production capabilities and would not require the use of specialized equipment, such as, for example, polymeric dithiocarbamates. Such polymers created are water soluble and can precipitate out of solution upon the capture of metal.

In yet another aspect of the disclosed technology, a method for removing metals from an aqueous stream is provided. The method comprises (i) providing a functionalized polymeric composition; (ii) adding the functionalized polymeric composition to an aqueous stream comprising a plurality of metal contaminants; (iii) allowing the polymeric composition to react with the metal contaminants to form an insoluble complex; and (iv) allowing the insoluble complex to settle out of solution or remove the insoluble complex through filtration.

The functionalized polymeric composition of the disclosed method comprises a backbone, and at least one compound having at least one thiol-functional group and/or at least one amino-functional group. The functionalized polymeric composition complexes with the metal contaminants. In some embodiments, the metal contaminants comprise at least one transition metal, a post-transition metal, a lanthanide, an actinide, arsenic, selenium, and/or tellurium.

In some embodiments, the transition metal is a cationic transition metal. In some embodiments, the cationic transition metal comprises Ag, Cu, Cd, Co, Hg, Ni, Pb, Pd, Pt, Tl, and/or Zn. In some embodiments, the cationic transition metal is divalent or monovalent.

It should be understood that adding the functionalized polymeric composition to the aqueous stream can be accomplished by standard physical-chemical separation techniques. For example, allowing the functionalized polymer to react with the metal followed by a separation technique, such as, but not limited to, settling or filtration. In some embodiments, the aqueous stream is provided by cooling tower blowdown, incinerator scrubbers, municipal water streams, mining operations, metal finishing operations, oil refinery operations or the like.

### EXAMPLES

The present technology will be further described in the following examples, which should be viewed as being illustrative and should not be construed to narrow the scope of the disclosed technology or limit the scope to any particular embodiments.

The present examples demonstrate the ability of the functionalized polymeric composition and method as described herein to remove soluble and insoluble cationic transition metals from water using standard jar testing procedures.

### Example 1

200 gm water was placed into a flask equipped with stirrer, heater, and temperature controller and then heated to 40° C. 132 gm of tannin was added over a period of 20 minutes. 93.7 gm of Cysteamine HCl was added over the period of 10 minutes. 66.2 gm of Formalin was added to the reaction flask over a period of 10 minutes at 40° C. The reaction mixture was then heated to 85° C. and stirred for about three hours. DI water was added to bring the product into the desired specification.

### Example 2

50 gm water was placed into a flask equipped with stirrer, heater, and temperature controller and then heated to 40° C. 33 gm of tannin was added over a period of 20 minutes. 18.8 gm of Cysteamine HCl was added over the period of 10 minutes. 13.4 gm of Formalin was added to the reaction flask over a period of 10 minutes at 40° C. The reaction mixture was then heated to 85° C. and stirred for about three hours. DI water was added to bring the product into the desired specification.

### Example 3

50 gm water was placed into a flask equipped with stirrer, heater, and temperature controller and then heated to 40° C. 33 gm of tannin was added over a period of 20 minutes. 18.8 gm of Cysteamine HCl was added over the period of 10 minutes. 2.73 gm of Monoethanolamine was added over the period of 10 minutes. 4.43 gm of HCl was added over the period of 10 minutes. 17.2 gm of Formalin was added to the reaction flask over a period of 10 minutes at 40° C. The reaction mixture was then heated to 85° C. and stirred for about three hours. DI water was added to bring the product into the desired specification.

NMR was used to analyze incorporation of nitrogens into the polymer for Examples 1, 2, and 3, as shown in Table 1 below.

TABLE 1

| | Percent |
|---|---|
| | bonded |
| Example 1 | 56.45 |
| Example 2 | 54.00 |
| Example 3 | 64.52 |

### Example 4

300 gm of THF was added to a 3-neck flask equipped with stirrer, thermocouple, and heating mantle. 31.4 gm of poly(ethylene-alt-maleic anhydride) was added over a period of 5 minutes. 23.0 g of cysteamine hydrochloride was added over a 5-minute period and heated to reflux (˜67° C.). 1.8 g of sulfuric acid was added and held for 5 hours. The solution was then cooled and the product precipitated out of the THF solution through the addition of DI water. The precipitated polymer was then filtered and dried. The dried polymer was suspended into DI water and caustic was added to solubilize the polymer and bring it to the desired specification.

Synthetic water was created with approximately 1.2 ppm of Cd⁺², Co⁺², Cu⁺², Ni⁺², Zn⁺². To create the synthetic water HEPES buffer was dissolved into deionized water so that the final solution was 0.01N HEPES. Stock solutions of chloride salts were then added to the buffered water to achieve the desired amount of metal ion. Mercury was added to 1 pb using an ICP standard in some experiments. In some experiments 500 ppm calcium was added using a stock solution of calcium chloride. The water was then adjusted to pH 8 slowly with IN NaOH.

500 mL aliquots of the synthetic water were tested using a standard jar tester. The metals removal product was dosed into the jar while mixing at 100 rpm. Two minutes was allowed to elapse before the mixing was reduced to 35 rpm. After 5 minutes the mixing was stopped, and the jars were allowed to settle for an additional 5 minutes. Samples of the supernatant were removed for ICP analysis of the remain metals. Metals concentration was measured for unfiltered and 0.45 micron filtered samples.

### Example 5

Polymer from Example 1 was tested for ability to remove metals in synthetic water with Cd⁺², Co⁺², Cu⁺², Ni⁺², Zn⁺², and Hg buffered at pH 8. Results Table 2 provides the results for the metal concentration for jars with Example 1 in synthetic water.

TABLE 2

| Example 1 | Total concentration | | | | | Soluble concentration (0.45 micron filter) | | | | |
|---|---|---|---|---|---|---|---|---|---|---|
| polymer (ppm) | 0 | 20 | 40 | 80 | 120 | 0 | 20 | 40 | 80 | 120 |
| cadmium(ppm) | 0.9 | 0.826 | 0.593 | 0.293 | 0.177 | 0.842 | 0.707 | 0.488 | 0.216 | 0.12 |
| cobalt(ppm) | 0.904 | 0.87 | 0.72 | 0.381 | 0.195 | 0.856 | 0.825 | 0.675 | 0.327 | 0.151 |
| copper(ppm) | 0.888 | 0.384 | 0.15 | 0.072 | 0.053 | 0.434 | 0.006 | 0.003 | 0.001 | 0.001 |
| mercury (ppt) | 312 | 188 | 69 | 28 | 38 | 215 | <5.0 | <5.0 | <5.0 | <5.0 |
| nickel(ppm) | 0.915 | 0.883 | 0.761 | 0.538 | 0.353 | 0.845 | 0.831 | 0.713 | 0.478 | 0.306 |
| zinc(ppm) | 0.934 | 0.716 | 0.347 | 0.136 | 0.086 | 0.842 | 0.525 | 0.236 | 0.075 | 0.043 |

### Comparative Example 6

Comparative Example 6 was performed to show effect of unbonded cysteamine with a tannin polymer. A conventional tannin coagulant was dosed to the synthetic water at the start of the two-minute mix at 100 rpm and cysteamine HCl was added 1 min after the tannin coagulant. Table 3 provides the results for the metals concentration for jars with conventional tannin coagulant and cysteamine HCl in synthetic water.

TABLE 3

| | Total concentration | | | | | | | Soluble concentration (0.45 micron filter) | | | | | | |
|---|---|---|---|---|---|---|---|---|---|---|---|---|---|---|
| ppm tannin coagulant | 80 | 80 | 80 | 80 | 80 | 80 | 80 | 80 | 80 | 80 | 80 | 80 | 80 | 80 |
| ppm cysteamine HCl | 0 | 5 | 10 | 20 | 30 | 40 | 60 | 0 | 5 | 10 | 20 | 30 | 40 | 60 |
| cadmium(ppm) | 0.648 | 0.643 | 0.669 | 1.05 | 1.02 | 0.982 | 1.03 | 0.506 | 0.492 | 0.472 | 0.399 | 0.375 | 0.384 | 0.656 |
| cobalt(ppm) | 0.61 | 0.66 | 0.81 | 1.25 | 1.24 | 1.23 | 1.27 | 0.46 | 0.45 | 0.56 | 0.66 | 0.82 | 0.97 | 1.08 |
| copper(ppm) | 0.13 | 0.24 | 0.37 | 1.12 | 1.13 | 1.08 | 1.13 | <0.01 | <0.01 | 0.05 | 0.02 | 0.18 | 0.32 | 0.62 |
| nickel(ppm) | 0.636 | 0.657 | 0.671 | 1.19 | 1.18 | 1.13 | 1.21 | 0.513 | 0.499 | 0.436 | 0.426 | 0.453 | 0.474 | 0.812 |
| zinc(ppm) | 0.263 | 0.291 | 0.34 | 1.03 | 1.02 | 1.03 | 1.05 | 0.09 | 0.087 | 0.072 | 0.057 | 0.041 | 0.059 | 0.511 |

### Example 7

Polymer from Example 4 was tested for ability to remove metals in synthetic water with Cd⁺², Co⁺², Cu⁺², Ni⁺², Zn⁺², and 500 pmm calcium buffered at pH 8. Table 4 provides the results for the metals concentration for jars with Example 5 polymer in synthetic water.

TABLE 4

| | | | | | | Soluble concentration | | | | |
|---|---|---|---|---|---|---|---|---|---|---|
| | Total concentration | | | | | (0.45 micron filter) | | | | |
| Example 4 | 0 | 100 | 200 | 300 | 400 | 0 | 100 | 200 | 300 | 400 |
| cadmium(ppm) | 1 | 0.496 | 0.216 | 0.157 | 0.117 | 1.01 | 0.227 | 0.064 | 0.029 | 0.017 |
| cobalt(ppm) | 1.12 | 1.04 | 0.94 | 0.89 | 0.86 | 1.14 | 0.99 | 0.87 | 0.81 | 0.78 |
| copper(ppm) | 1.14 | 0.42 | 0.24 | 0.2 | 0.17 | 1.02 | 0.04 | <0.01 | 0.01 | 0.01 |
| nickel(ppm) | 1.12 | 1.11 | 0.931 | 0.861 | 0.876 | 1.1 | 1.05 | 0.847 | 0.825 | 0.834 |
| zinc(ppm) | 1 | 0.752 | 0.491 | 0.393 | 0.326 | 0.997 | 0.592 | 0.349 | 0.255 | 0.201 |

Metals Removal from Flue-Gas Desulfurization (FGD) Water:

The pH of 500 mL of the FGD water was adjusted to 8 with 5% lime slurry while mixing at 100 rpm. After the pH was adjusted the water was mixed for ten minutes. The metals removal product was then added while mixing at 100 rpm. After two minutes the 50 ppm ferric chloride was added. Mixing at 100 rpm was continued for 3.5 minutes. A 30% high molecular weight anionic flocculant at 2 ppm was added and after 30 seconds the speed was reduced to 35 rpm slow mix. The slow mix was three minutes long followed by a five-minute settling period. Metals concentration was measured for unfiltered and 0.45 micron filtered samples.

### Example 8

Polymer from Example 2 and 3 were tested for ability to remove mercury in FGD water. Table 5 provides the results for the metals concentration for jars with Example 2 and 3 polymer in FGD water.

TABLE 5

| | | | | | | Soluble concentration | | | | |
|---|---|---|---|---|---|---|---|---|---|---|
| | Total concentration | | | | | (0.45 micron filter) | | | | |
| | Raw | 0 | 25 | 50 | 100 | Raw | 0 | 25 | 50 | 100 |
| Example 2 | | | | | | | | | | |
| polymer (ppm) | | | | | | | | | | |
| mercury (ppt) | 16200 | 145 | 95.8 | 76 | 39.5 | 5.5 | 7.2 | 8 | 5.5 | 3.8 |
| Example 3 | | | | | | | | | | |
| polymer (ppm) | | | | | | | | | | |
| mercury (ppt) | 16200 | 145 | 65.5 | 52 | 41.5 | 5.5 | 7.2 | 2.2 | 2.2 | <1.0 |

### Example 9

5.0 gm of PEI was added to a 3-neck flask equipped with a stirrer, thermocouple and heating mantle. 31.3 gm of DI water was then added and heated to 40° C. 15.4 gm of DL-homocysteine thiolactone was added to the flask creating a thick, white solution. This was heated to 90° C. and held for 8 hours. The solution was then cooled to room temperature and caustic solution (50%) was then added to bring the product to the desired pH specification.

Synthetic water was created with approximately 1.2 ppm of Cd⁺², Co⁺², Cu⁺², Ni⁺², Zn⁺². To create the synthetic water HEPES buffer was dissolved into deionized water so that the final solution was 0.01N HEPES. Stock solutions of chloride salts were then added to the buffered water to achieve the desired amount of metal ion. The water was then adjusted to pH 8 slowly with IN NaOH.

500 mL aliquots of the synthetic water were tested using a standard jar tester. The metals removal product was dosed into the jar while mixing at 100 rpm. Two minutes was allowed to elapse before the mixing was reduced to 35 rpm. After 5 minutes the mixing was stopped, and the jars were allowed to settle for an additional 5 minutes. Samples of the supernatant were removed for ICP analysis of the remain metals. Metals concentration was measured for unfiltered and 0.45 micron filtered samples.

### Example 10

Polymer from Example 10 was tested for ability to remove metals in synthetic water with Cd⁺², Co⁺², Cu⁺², Ni⁺², Zn⁺². Results are shown in Table 6 provides the results for the metals concentration for jars with Example 9 in synthetic water.

TABLE 6

| | | | | | | | Soluble concentration | | | | | |
|---|---|---|---|---|---|---|---|---|---|---|---|---|
| Example 10 | Total concentration | | | | | | (0.45 micron filter) | | | | | |
| (ppm) | 0 | 10 | 20 | 40 | 80 | 120 | 0 | 10 | 20 | 40 | 80 | 120 |
| cadmium(ppm) | 1.14 | 1.06 | 1.08 | 1.08 | 1.05 | 1.09 | 0.99 | 0.34 | 0.047 | 0.263 | 0.765 | 0.862 |
| cobalt(ppm) | 1.11 | 1.05 | 1.05 | 1.05 | 1.04 | 1.07 | 0.95 | 0.8 | 0.58 | 0.37 | 0.74 | 0.81 |
| copper(ppm) | 1.09 | 0.95 | 0.95 | 0.94 | 0.94 | 0.99 | 0.27 | 0.05 | 0.04 | 0.13 | 0.32 | 0.33 |
| nickel(ppm) | 1.14 | 1.13 | 1.13 | 1.13 | 1.08 | 1.11 | 0.929 | 0.791 | 0.493 | 0.274 | 0.732 | 0.752 |
| zinc(ppm) | 1.07 | 0.965 | 0.974 | 0.994 | 0.992 | 1.01 | 0.76 | 0.58 | 0.297 | 0.249 | 0.676 | 0.747 |

Metals Removal from Flue-Gas Desulfurization (FGD) Water:

The pH of 500 mL of the FGD water was adjusted to 8 with 5% lime slurry while mixing at 100 rpm. After the pH was adjusted the water was mixed for ten minutes. The metals removal product was then added while mixing at 100 rpm. After two minutes the 50 ppm ferric chloride was added. Mixing at 100 rpm was continued for 3.5 minutes. A 30% high molecular weight anionic flocculant at 2 ppm was added and after 30 seconds the speed was reduced to 35 rpm slow mix. The slow mix was three minutes long followed by a five-minute settling period. Metals concentration was measured for unfiltered and 0.45 micron filtered samples.

### Example 11

Polymer from Example 9 was tested for ability to remove mercury in FGD water. Table 7 provides the results for the metals concentration for jars with Example 10 polymer in FGD water.

TABLE 7

| Example | Total concentration | | | | | | | Soluble concentration (0.45 micron filter) | | | | | | |
|---|---|---|---|---|---|---|---|---|---|---|---|---|---|---|
| 10(ppm) | Raw | 0 | 5 | 10 | 20 | 40 | 80 | Raw | 0 | 5 | 10 | 20 | 40 | 80 |
| mercury | 17000 | 147 | 333 | 266 | 86.9 | 53 | 71.8 | 6.3 | 10.3 | 257 | 210 | 50 | 7.7 | 13.2 |
| (ppt) | | | | | | | | | | | | | | |

In the foregoing specification, the present technology has been described with reference to specific embodiments thereof. While embodiments of the disclosed technology have been described, it should be understood that the present disclosure is not so limited and modifications may be made without departing from the disclosed technology. The scope of the disclosed technology is defined by the appended claims, and all devices, processes, and methods that come within the meaning of the claims, either literally or by equivalence, are intended to be embraced therein.

1. A functionalized polymeric composition, the composition comprising:
a backbone; and
at least one compound having at least one thiol-functional group or at least one amino-functional group.

2. The composition as recited in claim 1, wherein said backbone comprises a nitrogen-containing polymer, a maleic anhydride copolymer, a tannin, or polymeric scaffold.

3. The composition as recited in claim 2, wherein said nitrogen-containing polymer is a polyamine having a Mw of at least 2,000, and wherein said polymer comprises at least one primary or secondary amine capable of functionalization.

4. The composition as recited in claim 3, wherein said nitrogen containing polymer is polyethylenimine (PEI).

5. The composition as recited in claim 1, wherein said compound is cysteamine, a thiolactone, or derivative thereof.

6. A method of preparing a functionalized polymeric composition, the method comprising:
(i) providing a backbone; and
(ii) reacting said backbone with an amino-thiol compound to obtain a functionalized polymeric composition.

7. The method as recited in claim 6, wherein said backbone comprises a nitrogen-containing polymer, a maleic anhydride copolymer, a tannin, or polymeric scaffold.

8. The method as recited in claim 6, wherein said amino-thiol compound is cysteamine, thiolactone, or derivative thereof.

9. The method as recited in claim 6, wherein said functionalized polymeric composition is water soluble.

10. A method for removing metals from an aqueous stream, the method comprising:
(i) providing a functionalized polymeric composition;
(ii) adding the functionalized polymeric composition to an aqueous stream comprising a plurality of metal contaminants;
(iii) allowing said polymeric composition to react with said metal contaminants to form an insoluble complex; and
(iv) allowing said insoluble complex to settle out of solution or remove the insoluble complex through filtration.

11. The method as recited in claim 10, wherein said functionalized polymeric composition comprises a backbone, and at least one compound having at least one thiol-functional group or at least one amino-functional group.

12. The method as recited in claim 10, wherein said aqueous stream is provided by cooling tower blowdown, incinerator scrubbers, municipal water streams, mining operations, metal finishing operations, or oil refinery operations.

13. The method as recited in claim 10, wherein said functionalized polymeric composition complexes with said metal contaminants.

14. The method as recited in claim 13, wherein said metal contaminants comprise at least one transition metal, post-transition metal, lanthanide, actinide, arsenic, selenium, and/or tellurium.

15. The method as recited in claim 14, wherein said transition metal is a cationic transition metal.

16. The method as recited in claim 15, wherein said cationic transition metal comprises Ag, Cu, Cd, Co, Hg, Ni, Pb, Pd, Pt, Tl, and/or Zn.

17. The method as recited in claim 16, wherein said cationic transition metal is divalent or monovalent.
